(19) United States
(12) Patent Application Publication
(10) Pub. No.: US 2013/0156374 A1
(43) Pub. Date: Jun. 20, 2013

(54) OPTICAL-ELECTRICAL MODULE

(71) Applicant: KAI-WEN WU, New Taipei (TW)

(72) Inventor: KAI-WEN WU, New Taipei (TW)

(73) Assignee: HON HAI PRECISION INDUSTRY CO., LTD., New Taipei (TW)

(21) Appl. No.: 13/446,258

(22) Filed: Apr. 13, 2012

(30) Foreign Application Priority Data
Dec. 19, 2011 (TW) 100147111

(51) Int. Cl. G02B 6/32

(52) U.S. Cl. 385/33

(57) ABSTRACT

An optical-electrical module includes a base board and an optical transmitting unit fixed on the base board. The optical transmitting unit includes an edge-emitting laser transmitting optical signals parallel to the base board, a driving integrated circuit for driving the edge-emitting laser to transmit optical signals, and a first lens unit for transmitting and converging the optical signals. Furthermore, the optical-electrical module can also include an optical receiving unit used to receive the optical signals transmitted by the optical transmitting unit and convert the optical signals into electrical signals. The optical receiving unit includes a photo diode, a transimpedance amplifier, and a second lens unit.

### BACKGROUND

1. Technical Field

The present disclosure relates to optical-electrical modules, particularly to an optical-electrical module configured for data transmission.

2. Description of Related Art

Many optical-electrical modules for data transmission include a vertical-cavity-surface-emitting laser (VCSEL), a driving integrated circuit used for driving the vertical-cavity surface-emitting laser to transmit optical signals, and a lens unit for converging the optical signals or changing the transmission direction of the optical signals. However, the optical-electrical module is fixed perpendicular to a base board where the transmitted optical signals of the VCSEL need to be reflected to be parallel to the base board by a reflector. This causes attenuation of the optical signals.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the optical-electrical module. Moreover, in the drawings like reference numerals designate corresponding parts throughout the several views. Wherever possible, the same reference numerals are used throughout the drawings to refer to the same or like elements of an embodiment.

FIG. 1 is a cross-sectional view of an embodiment of an optical-electrical module.

FIG. 2 is another cross-sectional view of the embodiment of the optical-electrical module of FIG. 1.

### DETAILED DESCRIPTION

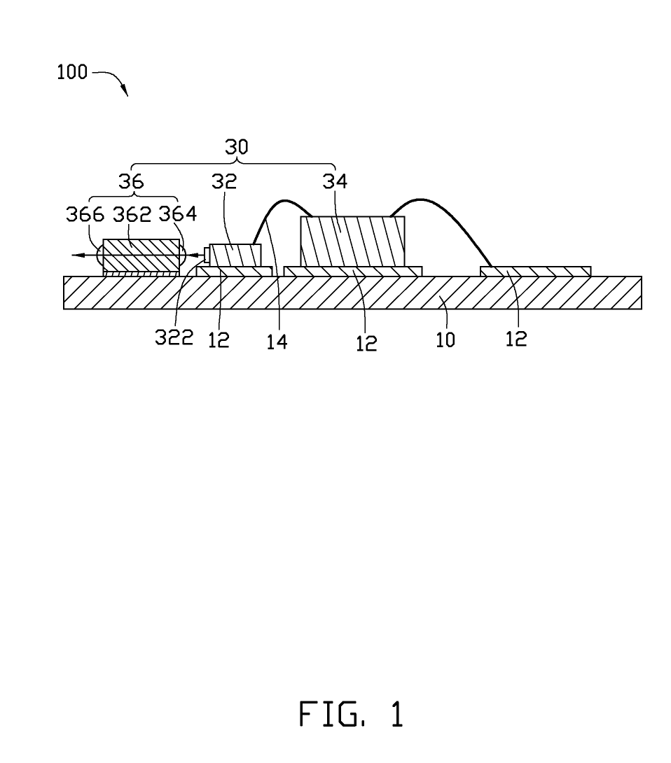

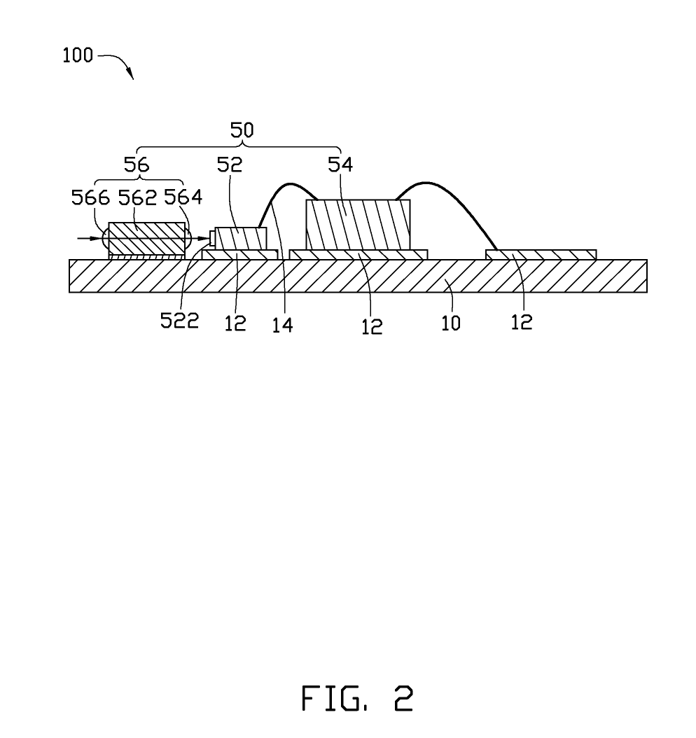

Referring to FIGS. 1 and 2, an embodiment of an optical-electrical module 100 for data transmission is shown. The optical-electrical module 100 comprises a base board 10, an optical transmitting unit 30 (as shown in FIG. 1) and an optical receiving unit 50 (as shown in FIG. 2) fixed on the base board 10 adjacent to the optical transmitting unit 30.

The base board 10 is an integrated circuit board. A plurality of solder masks 12 are formed on the surface of the base board 10. The optical transmitting unit 30 comprises an edge-emitting laser 32, a driving integrated circuit 34, and a first lens unit 36. The edge-emitting laser 32 and the driving integrated circuit 34 configured next to each other are both fixed on one solder mask 12, respectively. The edge-emitting laser 32 is electrically connected to the driving integrated circuit 34 with a wire 14.

The first lens unit 36 is fixed on the base board 10 adjacent to the edge-emitting laser 32. The first lens unit 36 comprises a main body 362, and two convex lenses 364, 366 configured to be disposed at two opposite ends of the main body 362. The main body 362 and the two convex lenses 364, 366 are all made of transparent organic glass. The main body 362 is used as a transmission medium to transmit the optical signals transmitted by the edge-emitting laser 32. The two convex lenses 364, 366 transmit and converge the optical signals transmitted by the edge-emitting laser 32. In the illustrated embodiment, the focus of the convex lens 364 is located opposite to the focus of the convex lens 366 for converging the optical signals transmitted by the edge-emitting laser 32.

The edge-emitting laser 32 defines an emitting window 322 adjacent to the first lens unit 36. The emitting window 322 is located opposite to the convex lens 364. The optical signal transmitted by the edge-emitting laser 32 is parallel to the base board 10. The optical signal transmitted by the edge-emitting laser 32 is perpendicularly irradiated on the convex lens 364 through the emitting window 322. The optical signals transmitted by the edge-emitting laser 32 are converged by the convex lenses 364, 366 successively and are transmitted to other electrical components by an optical fiber (not shown).

The optical receiving unit 50 is used to receive the optical signals transmitted by the optical transmitting unit 30 and convert the optical signals into electrical signals. The optical receiving unit 50 comprises a photo diode 52, a transimpedance amplifier 54, and a second lens unit 56. The photo diode 52 and the transimpedance amplifier 54 configured next to each other are both fixed on a solder mask 12, respectively. The photo diode 52 is electrically connected to the transimpedance amplifier 54 with a wire 14. The second lens unit 56 fixed to the base board 10 is configured to be disposed adjacent to the photo diode 52. The photo diode 52 defines a receiving window 522 adjacent to the second lens unit 56.

The second lens unit 56 is similar to the first lens unit 36. The second lens unit 56 comprises a main body 562, and two convex lenses 564, 566 configured at two opposite ends of the main body 562. The two convex lenses 564, 566 are used to transmit and converge the optical signals transmitted by the edge-emitting laser 32. In the illustrated embodiment, the focus of the convex lens 564 is located opposite to the focus of the convex lens 566 to converge the optical signals transmitted by the edge-emitting laser 32. The convex lens 564 is configured opposite to the receiving window 522 of the photo diode 52. The optical signals transmitted by the optical transmitting unit 30 are transmitted to the photo diode 52 after transmitting and converging by the second lens unit 56. The photo diode 52 converts the optical signals into electrical signals, and the electrical signals amplified by the transimpedance amplifier 54 are transmitted to other interfaces or electrical components.

In alternative embodiments, the optical transmitting unit 30 can transmit optical signals to an another optical-electrical module. At the same time, the optical receiving unit 50 can receive optical signals transmitted by the another optical-electrical module. Therefore, the optical-electrical module 100 and the another optical-electrical module can exchange or transmit optical signals with each other.

In alternative embodiments, the first lens unit 36 and the second lens unit 56 can be configured in the same lens unit, the optical signals transmitted to the optical-electrical module 100 from the another optical-electrical module and the optical signals transmitted to the another optical-electrical module from the optical-electrical module 100 are thereby transmitted by the same lens unit. It will reduce the cost of the optical-electrical module 100.

In alternative embodiments, the optical receiving unit 50 of the optical-electrical module 100 can be emitted. The optical-electrical module 100 is just used to transmit optical signals to another optical-electrical module 100 with an optical receiving unit.

In summary, the optical signals transmitted by the optical transmitting unit 30 are parallel to the base 10, thereby reducing the attenuation of the optical signals as well as providing benefit by omitting a required additional reflector of conventional optical-electrical modules to change the transmitting direction of the optical signals. At the same time, the manufacturing cost of the optical-electrical module 100 is reduced by omitting an additional reflector in a lens unit.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An optical-electrical module, comprising:
a base board; and
an optical transmitting unit fixed on the base board, the optical transmitting unit comprising an edge-emitting laser transmitting a plurality of optical signals in a direction parallel to the base board, a driving integrated circuit for driving the edge-emitting laser to transmit the optical signals, and a first lens unit for transmitting and converging the optical signals.

2. The optical-electrical module of claim 1, wherein the first lens unit comprises a main body, and two convex lenses configured to be disposed at two opposite ends of the main body, and the focus of each of the two convex lens are opposite to each other to converge the optical signals transmitted by the edge-emitting laser.

3. The optical-electrical module of claim 2, wherein the edge-emitting laser defines an emitting window adjacent to the first lens unit, and the emitting window is located opposite to a convex lens of the first lens unit adjacent to the edge-emitting laser.

4. The optical-electrical module of claim 3, further comprises a photo diode and a transimpedance amplifier, the photo diode is used for converting the optical signals transmitted by the edge-emitting laser into a plurality of electrical signals, and the transimpedance amplifier is used for amplifying the electrical signals.

5. The optical-electrical module of claim 4, wherein the photo diode defines a receiving window adjacent to the first lens unit, and the receiving window is opposite to the other convex lens of the first lens unit.

6. The optical-electrical module of claim 1, further comprises an optical receiving unit, the optical receiving unit comprises a photo diode, a transimpedance amplifier, and a second lens unit.

7. The optical-electrical module of claim 6, wherein the second lens unit comprises a main body, and two convex lenses configured at two opposite ends of the main body, and the focus of each of the two convex lens are opposite to each other to converge the optical signals transmitted by the edge-emitting laser.

8. The optical-electrical module of claim 7, wherein the photo diode defines a receiving window adjacent to the second lens unit, and the receiving window is opposite to a convex lens of the second lens unit.
